(19) United States
(12) Patent Application Publication
(10) Pub. No.: US 2020/0368953 A1
(43) Pub. Date: Nov. 26, 2020

(54) DISPLAY DEVICE AND DISPLAY METHOD

(71) Applicant: FANUC CORPORATION, Yamanashi (JP)

(72) Inventor: Shingo KOMIYA, Yamanashi-ken (JP)

(21) Appl. No.: 16/878,859

(22) Filed: May 20, 2020

(30) Foreign Application Priority Data
May 23, 2019 (JP) 2019-096698

(51) Int. Cl. B29C 45/76; B29C 45/77

(52) U.S. Cl. CPC B29C 45/7626; B29C 45/77; B29C 2945/76076; B29C 2045/7606; B29C 2945/76006; B29C 45/768

(57) ABSTRACT

A display device causes a display unit to display a first graph showing the temporal change of a feature value of a physical quantity measured in each molding cycle of an injection molding machine and a second graph showing the temporal change of events that occurred in the injection molding machine, with the time axes of the first graph and the second graph being defined in the same direction on the same scale, based on cycle information indicating the molding cycle in which the feature value was measured and occurrence period information indicating the occurrence time period of the events.

### CROSS-REFERENCE TO RELATED APPLICATION

This application is based upon and claims the benefit of priority from Japanese Patent Application No. 2019-096698 filed on May 23, 2019, the contents of which are incorporated herein by reference.

### BACKGROUND OF THE INVENTION

### Field of the Invention

The present invention relates to a display device and a display method for displaying operation history of an injection molding machine.

### Description of the Related Art

In an injection molding machine, its operation history is managed according to various requirements such as mass production of injection molded products with a high degree of accuracy. Since the operation history of an injection molding machine includes diverse items, it is difficult to display the entire operation history on a display such as a liquid crystal display or the like.

In order to display the operating rate of an injection molding machine in a user friendly manner, Japanese Laid-Open Patent Publication No. 2003-001686 discloses a configuration in which fluctuation in quality data, occurrence of abnormalities, and changes of settings, for the past X hours, are displayed on a single screen by putting time on the horizontal axis.

### SUMMARY OF THE INVENTION

However, since, in Japanese Laid-Open Patent Publication. No. 2003-001686, multiple pieces of information are displayed on one screen, the operator may become unable to know which information should be focused on. In other words, there is a concern that presentation of a large amount of information on one screen makes it difficult for the operator to understand.

It is therefore an object of the present invention to provide a display device and a display method that makes it possible to display information in an easily understood manner even when a large amount of information is presented.

The first aspect of the present invention is a display device for displaying an operation history of an injection molding machine, including:

a first storage control unit configured to acquire a feature value of a physical quantity measured in each molding cycle of the injection molding machine and store the acquired feature value in a storage unit in association with cycle information indicating the molding cycle in which the feature value was measured;

a second storage control unit configured to acquire event information indicating the content of each of events that have occurred in the injection molding machine, and store the acquired event information in the storage unit in association with occurrence period information indicating an occurrence time period of each of the events; and

a display control unit configured to, based on the cycle information and the occurrence period information, cause a display unit to display a first graph showing temporal change of the feature value and a second graph showing temporal change of the events, with time axes of the first graph and the second graph being defined in the same direction on the same scale, wherein the display control unit is configured to display marks respectively indicating the events, in the second graph in a manner that the marks can be selectable.

The second aspect of the present invention is a display method for displaying an operation history of an injection molding machine, including:

a first storing step of acquiring a feature value of a physical quantity measured in each molding cycle of the injection molding machine and storing the acquired feature value in a storage unit in association with cycle information indicating the molding cycle in which the feature value was measured;

a second storing step of acquiring event information indicating content of each of events that have occurred in the injection molding machine and storing the acquired event information in the storage unit in association with occurrence period information indicating an occurrence time period of each of the events; and

a displaying step of, based on the cycle information and the occurrence period information, causing a display unit to display a first graph showing temporal change of the feature value and a second graph showing temporal change of the events, with time axes of the first graph and the second graph being defined in the same direction on the same scale, wherein the displaying step displays marks respectively indicating the events, in the second graph in a manner that the marks are selectable.

According to the present invention, since the operator can select one of multiple marks that indicates an event of interest, it is possible to reduce the risk of the operator losing track of the information to be focused on, without reducing the amount of information displayed on one screen. As a result, the operator can easily access the necessary information even if there is a large amount of information displayed.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing a configuration of an injection molding system according to an embodiment;

FIG. 2 is a block diagram showing a configuration of a display device;

FIG. 3 is a diagram of a display screen showing an operation history of an injection molding machine;

FIG. 4 is a diagram showing an example in which part of the display screen of FIG. 3 is highlighted;

FIG. 5 is a diagram of a screen showing details;

FIG. 6 is a diagram showing an example in which part of the display screen of FIG. 3 is changed;

FIG. 7 is a flowchart for explaining display processing; and

FIG. 8 is a block diagram illustrating a configuration of an injection molding system according to a modified example.

### DESCRIPTION OF THE PREFERRED EMBODIMENTS

The present invention will be detailed hereinbelow by giving a preferred embodiment with reference to the accompanying drawings.

### Embodiment

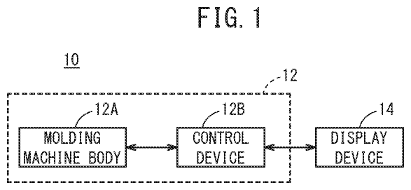

The configuration of an injection molding system 10 will be described with reference to FIG. 1. The injection molding system 10 includes an injection molding machine 12 and a display device 14.

The injection. molding machine 12 is a machine that injecting resin in a molten state into a mold, cools the resin, and then removes the cooled resin from the mold. The injection molding machine 12 includes a molding machine body 12A and a control device 12B that controls the molding machine body 12A.

The molding machine body 12A includes a mold that can be opened and closed, a cooling mechanism that cools the mold, a cylinder that injects resin into the mold, a screw that can move while rotating inside the cylinder, and a plurality of sensors. Specific examples of the sensors include a pressure sensor, a position sensor, a speed sensor, and a timer. The molding machine body 12A implements a mold closing step, an injection step, a pressure-holding step, a metering step, a cooling step, and a mold opening step, for each molding cycle, under control of the control device 12B.

The mold closing step is a step of closing the opened mold. The injection step is a step of injecting melted resin (molten resin) into a closed mold. The pressure holding step is a step of applying a constant pressure (pack pressure) to the molten resin injected in the mold in the closed state. The metering step is a step of melting the resin put in the cylinder, using a screw. The cooling step is a step of cooling the molten resin injected in the mold in a closed state while applying a certain pressure. The mold opening step is a step of opening the closed mold and taking out the cooled resin from the mold.

The control device 12B appropriately controls the molding machine body 12A based on the physical quantities detected by multiple sensors in the molding machine body 12A, so as to establish designated molding conditions. The molding conditions may be set in advance as default or may be designated by the operator. Specific examples of the molding conditions include the resin injection speed, the injection amount of resin, the resin pack pressure, the cylinder temperature, the mold temperature, and the like.

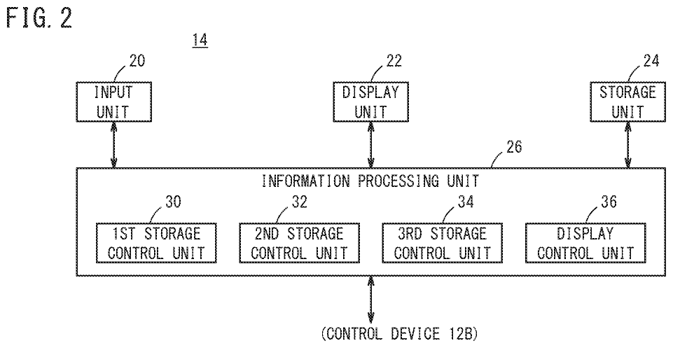

The display device 14 displays the operation history of the injection molding machine 12, and is connected to the control device 12B of the injection molding machine 12. As shown in FIG. 2, the display device 14 includes an input unit 20 for inputting information, a display unit 22 for displaying information, a storage unit 24 having one or more storage media for storing information, and an information processing unit 26 for processing information.

Specific examples of the input unit 20 include a mouse, a keyboard, and a touch panel formed on the display surface of the display unit 22. Specific examples of the display unit 22 include a liquid crystal display. Specific examples of the storage medium. include a hard disk.

The information processing unit 26 includes a processor. The processor runs the program stored in the storage medium of the storage unit 24, whereby the information processing unit 26 provides the functions of a first storage control unit 30, a second storage control unit 32, a third storage control unit 34, and a display control unit 36.

The first storage control unit 30 acquires a feature value of a physical quantity measured for each molding cycle of the injection molding machine 12. The first storage control unit 30 acquires a feature value from an unillustrated measuring unit. The measuring unit measures a feature value based on a physical quantity detected by a sensor of the injection molding machine 12, and may be provided in the control device 12B or provided in the display device 14 (the information. processing unit 26).

The first storage control unit 30 may collect one or more types of feature values. The operator can specify types of feature values to be collected by the first storage control unit 30, through the input unit 20. When the operator specifies one or more types of feature values, the first storage control unit 30 collects the type or types of feature values specified by the operator. On the other hand, when the operator does not specify any feature value type, the first storage control unit 30 acquires one or multiple types of feature values that have been specified beforehand as default.

The feature value includes at least one of the cycle time of the molding cycle, the injection of the resin, the metering time for the resin, the peak injection pressure of resin, and a front end position at which the screw for resin injection has reached the forefront position. In the present embodiment, the first storage control unit 30 acquires two types of feature values, specifically, the injection time and the peak injection pressure of the resin.

When acquiring the feature values, the first storage control unit 30 stores the acquired feature values in the storage medium of the storage unit 24 in association with cycle information indicating the molding cycle in which the feature values were measured. Here, the cycle information is generated by the above-described measuring unit, and the first storage control unit 30 acquires the cycle information from the measuring unit.

Specific examples of the cycle information include time, the cycle number, or the shot number at a time when a feature value was measured. The cycle number is a number indicating the order of the molding cycles, and indicates the ordinal number of the molding cycle from the start of molding. The shot number is a number indicating the order of resin injections, and indicates the ordinal number of the injection from the start of molding.

The second storage control unit 32 acquires event information as to the content of an event that has occurred in the injection molding machine 12. The second storage control unit 32 acquires event information from an unillustrated event information generator. The event information generator is provided in the control device 12B, and generates eventinformation indicating the event content every time an event occurs in the injection molding machine 12.

The event information acquired by the second storage control unit 32 may have one or more kinds of events. The type or types of events to be acquired by the second storage control unit 32 may be specified by the operator through the input unit 20. If the event type or types are specified by the operator, the second storage control unit 32 acquires event information on the event type of types specified by the operator. On the other hand, if the operator does not specify any event type, the second storage control unit 32 acquires event information indicating one or multiple types of events that have been specified in advance as defaults.

The events include at least one of alarm generation from the injection molding machine 12, operator's operation on the injection molding machine 12, and change of molding conditions of the injection molding machine 12. The event information includes specific content of the event and a unique number assigned to the type of event. In the present embodiment, it is assumed that the second storage control unit 32 acquires three kinds of event information, i.e., information on alarm generation from the injection molding machine 12, information on operator's operation on the injection molding machine 12, and information on change of the molding conditions of the injection molding machine 12.

When acquiring event information, the second storage control unit 32 stores the acquired event information in the storage medium of the storage unit 24 in association with the occurrence period information indicating the occurrence time period of the event indicated by the event information. When the storage unit 24 has multiple storage media, the second storage control unit 32 may store the event information in association with the occurrence period data, into the same storage medium as the storage medium into which the first storage control unit 30 stores the feature value in association with the cycle information, or into another storage medium. Note that the occurrence period data is generated by the aforementioned event information generator, and the second storage control unit 32 acquires the occurrence period information from the event information generator.

The third storage control unit 34 acquires status information indicating the operating state of the injection molding machine 12. The third storage control unit 34 acquires status information from an unillustrated status information generator. The status information generator is provided in the control device 12B, and monitors the operating state of the injection molding machine 12 to generate status information indicating the content of the operating state every time the operating state changes. The operating state includes automatic operation, manual operation, alarm generation, and stop.

When acquiring status information, the third storage control unit 34 stores the acquired status information in the storage medium of the storage unit 24 in association with the operating period information that indicates the operating time period of the operating state indicated by the status information. The operating period information is generated by the aforementioned status information generator, and the third storage control unit 34 acquires the operating period information from the status information generator.

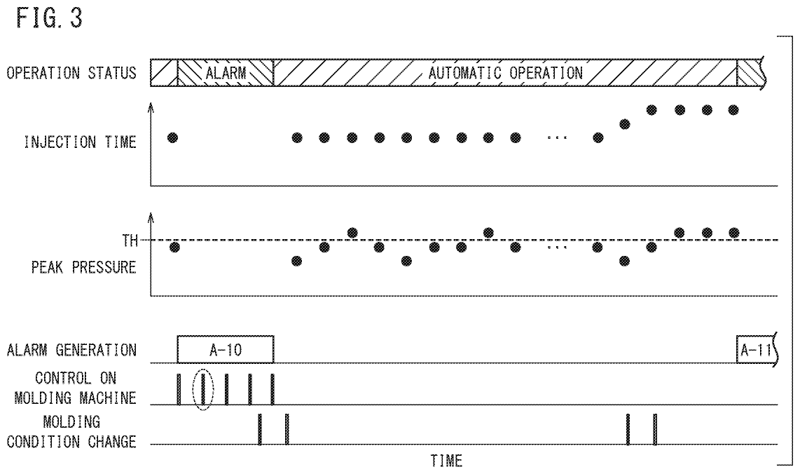

The display control unit 36 controls the display unit 22 and causes the display unit 22 to display a display screen showing the operation history of the injection molding machine 12. Now, a display screen that the display control unit 36 displays on the display unit 22 will be described with reference to FIG. 3.

The display control unit 36 causes the display unit 22 to display a first graph (a graph of first type or a first type graph) indicating the temporal change of a feature value, based on the feature value stored in the storage unit 24 in association with the cycle information. When multiple types of feature values are specified, the display control unit 36 causes the display unit 22 to display a first type graph of each kind of feature value.

In the present embodiment, as illustrated in FIG. 3, a first graph showing the temporal change of the injection time of the resin and another first graph showing the temporal change of the peak injection pressure of the resin are arranged above and below each other on the display unit 22. In these two first graphs thus arranged, the start points of time in the temporal changes coincide with each other, and the end points of time also coincide with each other, that is, the time axes of the two first graphs are defined in the same direction (the left-right direction of the display unit 22) on the same scale.

The start point of time in the temporal change in the first graphs may be defined by the point of time when molding is started, or a point of time that is specified by the operator through the input unit 20. The end point of time in the temporal change in the first graphs may be defined. by the end time of molding, or a point of time that is designated by the operator through the input unit 20.

In the first graphs, marks (hereinafter, referred to as first type marks or first marks) showing feature values are displayed. In the example of FIG. 3, the first marks showing the injection time of the resin are displayed on the upper first graph, and the first marks showing the peak injection pressure of the resin are displayed on the lower first graph. In the example of FIG. 3, the first marks displayed on the first graphs have a round shape.

The display control unit 36 causes the display unit 22 to display a second graph (a graph of second type or a second type graph) showing the temporal change of events, based on the event information stored in the storage unit 24 in association with the occurrence period information. When multiple kinds of events are designated, the display control unit 36 causes the display unit 22 to display the second graphs for respective event types.

In the present embodiment, as illustrated in FIG. 3, a second graph showing the temporal change of alarm generation from the injection molding machine 12 and another second graph showing the temporal change of operator's operation on the injection molding machine 12 (control of the molding machine) and a still another second graph showing the temporal change in the molding condition change of the injection molding machine 12, are arranged vertically on the display unit 22. In these three second graphs thus arranged, the start points of time in the temporal change coincide with each other and the end points of time coincide with each other, that is, the time axes of the three second graphs are defined in the same direction (the left-right direction of the display unit 22) on the same scale.

Note that the start point of time in the temporal change in the second graphs may be defined by the point of time when molding is started or a point of time that is specified by the operator through the input unit 20. The end point of time in the temporal evolution in the second graphs may be defined by the end time of the molding, or a point of time that is specified by the operator through the input unit 20.

In the second graphs, marks (hereinafter, referred to as second type marks or second marks) showing events are displayed. In the example of FIG. 3, the second marks indicating alarm generation in the injection molding machine 12 are displayed in the upper second graph in a selectable manner, the second marks indicating operator's operation on the injection molding machine 12 are displayed in the middle second graph in a selectable manner, and the second marks indicating the molding condition change of the injection molding machine 12 are displayed in the lower second graph in a selectable manner. Here, the second marks are different in shape from the first marks, and have a bar shape in the example of FIG. 3.

In the temporal change in the first graphs and the second graphs, the start points of time coincide with each other and the end point of times also coincide with each other, that is, the time axes of the first graphs and the second graphs are defined in the same direction (the left-right direction of the display unit 22) on the same scale.

The display control unit 36 causes the display unit 22 to display the first graphs showing the temporal change of feature values and the second graphs showing the temporal change of events with their time axes being defined in the same direction on the same scale. This makes it possible to easily compare the feature values and the events for easily understanding the relationship therebetween.

Further, the display control unit 36 displays the second marks showing events such that the second marks can be selected, i.e., in a selectable manner. Thus, the operator can select one of the second marks that shows an event on which the operator wants to focus. As a result, it is possible to reduce the risk of the operator losing track of the information to be focused on without reducing the amount of information displayed on the single screen. Thus, it is possible to clearly display a large amount of information in a user-friendly manner.

Further, the display control unit 36 displays the first graphs for respective types of feature values and the second graphs for respective types of events, i.e., one first graph for each type of feature value and one second graph for each type of event. Owing thereto, the operation history of the injection molding machine 12 can be grasped in detail.

Here, the display control unit 36 may vary at least one of the color, shape and pattern of the first mark displayed on the first graph for a different type of feature value. Owing thereto, the behavior of the feature value can be easily understood for each type. Similarly, the display control unit 36 may vary at least one of the color, shape and pattern of the second mark displayed on the second graph for a different type of event. As a result, the behavior of the event can be easily understood for each type.

The display control unit 36 causes the display unit 22 to display an indicator that shows the temporal change of the operating state, based on the status information stored in the storage unit 24 in association with the operating period information in the present embodiment, as shown in FIG. 3, a bar-shaped indicator is displayed at the top of the display unit 22, and the indicator is marked with different hatchings so as to distinguish operating states, each hatching containing text showing an operating state.

The display control unit 36 causes the display unit 22 to display the indicator indicating the temporal change of the operating state with the time axes of the first graph and the second graph being defined in the same direction on the same scale, whereby it is possible to easily compare the operating state of the injection molding machine 12, the feature values, and the events, for thereby easily understanding the relationship therebetween.

When a second mark is selected in the second graph, the display control unit 36 highlights at least the selected second mark. Here, the display control unit 36 may determine the selection of a second mark when the cursor displayed on the display unit 22 is moved to the second mark by the operation of the input unit 20. The display control unit 36 may determine the selection of a second mark when the second mark is clicked.

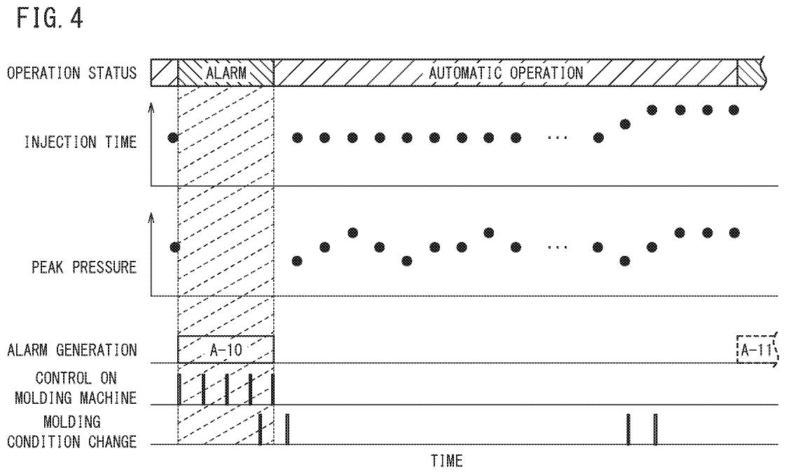

A case where a second mark of an alarm type number “A-10” is selected in the second graph showing the temporal change of the alarm generation shown in FIG. 3 is explained with reference to FIG. 4. The alarm type number is a unique number assigned to each type of alarm in the injection molding machine 12.

When the second mark of the alarm type number “A-10” is selected, the display control unit 36 highlights the selected second mark and other second marks that indicate the events (alarm generation) having the same content (alarm type number) as the selected second mark.

For example, as shown in FIG. 4, the display control unit 36 may perform highlighting by keeping the display of the second marks having the same alarm type number as the selected alarm type number of “A-10” unchanged, while changing the display of the second mark of “A-11”, different from “A-10”, into a broken line display. Alternatively, the display control unit 36 may perform highlighting by leaving the second marks having the same alarm type number as the selected alarm type number of “A-10” while erasing the second marks with alarm type numbers other than “A-10”. Alternatively, the display control unit 36 may perform highlighting by assigning a color different from that of the second marks having alarm type numbers other than “A-10”, to the second marks having the same alarm type number as the selected alarm type number of “A-10”.

Thus, the display control unit 36 highlights the selected second mark and other second marks indicating an event having the same content as the selected second mark, whereby it is possible for the operator to clearly grasp at what time and how often the event (alarm generation) of the same type as the selected second mark occurred.

In addition, when the second mark of the alarm type number “A-10” is selected, the display control unit 36 highlights in the first graphs the time zone corresponding to that of the selected second mark.

For example, as shown in FIG. 4, the display control unit 36 may highlight the time zone in the first graphs with hatching. Alternatively, the display control unit 36 may highlight the time zone in the first graphs with a different color from that of the other time zones.

By highlighting the time zone in the first graphs corresponding to the time region to which the selected second mark belongs, the display control unit 36 enables the operator to clearly grasp the tendency of the feature value within, and before and after the time zone corresponding to the time region where a specific event (alarm) occurred.

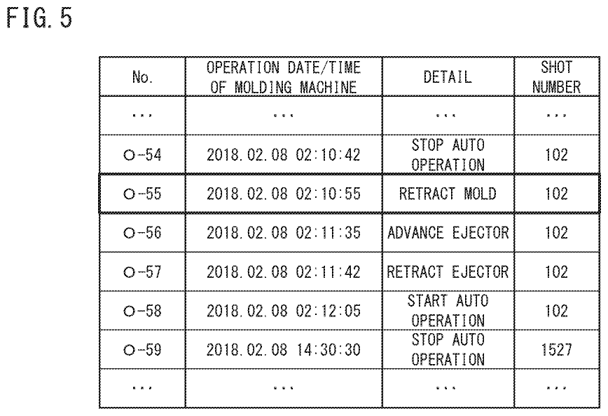

Next, a case where a second mark surrounded by the broken line, shown in FIG. 3, is selected from the second marks in the second graph indicating the temporal change of the operator's operation on the injection molding machine 12 (control on the molding machine) is explained with reference to FIG. 5.

When the second mark surrounded by the broken line is selected, the display control unit 36 causes the display unit 22 to display a detailed screen in which the details of events that have occurred within a predetermined period including the point of time corresponding to the selected second mark are listed in temporal order.

In the present embodiment, as shown in FIG. 5, a unique number (No.), which is assigned to each type of operation performed by the operator on the injection molding machine 12, the operation date and time, the detail (content) of the operation, and the shot number of a shot that is closest to a point of time at which the operation was performed are displayed on the detailed screen. In the example of FIG. 5, the item corresponding to the selected second mark is highlighted by the thick frame.

By displaying such a detailed screen on the display unit 22, the display control unit 36 enables the operator to grasp in detail the tendency around the point of time when a specific event occurred. The display control unit 36 may display the detailed screen in place of the display screen shown in FIG. 3, or may display the detailed screen together with the display screen.

Next, a case where a threshold TH is set for the peak injection pressure (peak pressure) of the resin illustrated in FIG. 3 will be described.

When a threshold TH is set for the peak injection pressure (peak pressure) of the resin through the input unit 20, the display control unit 36 extracts data points at which the feature value is equal to or greater than the threshold TH, based on the feature value stored in the storage unit 24 association with the cycle information.

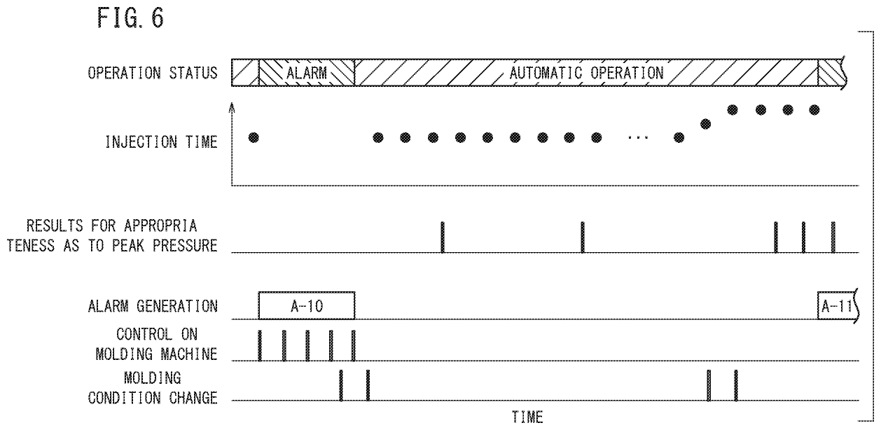

Upon having extracted data points at which the feature value is equal to or greater than the threshold TH, the display control unit 36 causes the display unit 22 to display, as results of appropriateness for the peak pressure, a third graph (a graph of third type or a third type graph), as shown in FIG. 6, which shows the temporal change of the feature value at the extracted data points, in place of the first graph. The time axis in the third graph is defined in the same direction (the left-right direction of the display unit 22) on the same scale as the time axis in the first graph.

Thus, the display control unit 36 causes the display unit 22 to display the third graph showing the temporal change of the feature value for which the value at its data point is equal to or greater than the set threshold TH, with its time axis being defined in the same direction on the same scale as the time axis of the first graph, whereby possible for the operator to clearly grasp at what tame and how often the feature value reaches or exceeds the threshold.

Here, depending on the type of feature value for which a threshold TH should be set, the display control unit 36 may be configured to extract data points at which the feature value is smaller than the set threshold TH, such as in a case where the feature value is the front end position at which the screw for resin injection has reached the forefront position. In this case, the display control unit 36 causes the display unit 22 to display a third graph showing the temporal change of the feature value for which the value at its data point is less than the threshold TH, with its time axis being defined in the same direction on the same scale as the time axis of the first graph.

Though the display control unit 36 displays the third graph on the display unit 22 instead of the first graph, the display control unit 36 may display the third graph on the display unit 22 together with the first graph. When displaying the third graph together with the first graph on the display unit 22, the display control unit 36 may highlight the extracted data points at which the feature value is equal to or greater than the threshold TH, in the first graph. Alternatively, the display control unit 36 may highlight the extracted points at which the feature value is equal to or greater than the threshold TH, on the first graph, without displaying the third graph.

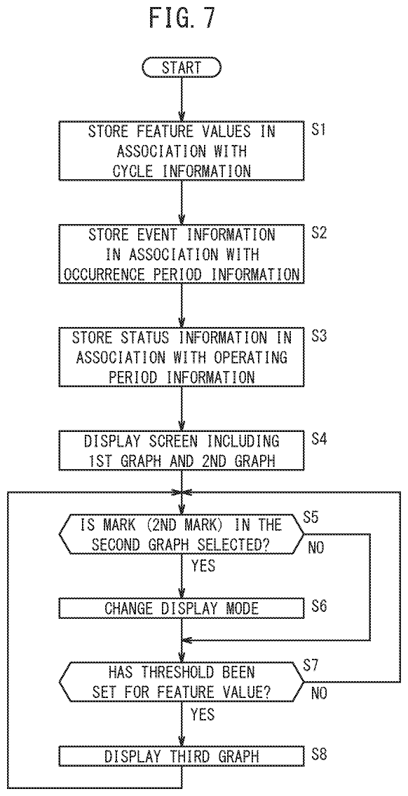

Next, according to a display method for the display device 14, a flow of display processing of the display device 14 will be described with reference to FIG. 7.

At step S1, the first storage control unit 30 acquires feature values of physical quantities measured for each molding cycle of the injection molding machine 12, and stores the acquired feature values in the storage unit 24 in association with the cycle information. For example, after the feature values in each molding cycle have been stored in the storage unit 24 in association with the cycle information in the molding period from the molding start time to the molding end time, the display process proceeds to step S2.

At step S2, the second storage control unit 32 acquires event information indicating the details (content) of events that have occurred in the injection molding machine 12, and stores the acquired event information in the storage unit 24 in association with the occurrence period information. For example, after the event, information in the molding period from the molding start time to the molding end time has been stored in the storage unit 24 in association with the occurrence period information, the display process proceeds to step S3.

At step S3, the third storage control unit 34 acquires status information indicating the operating state of the injection molding machine 12, and stores the acquired status information in the storage medium of the storage unit 24 in association with the operating period information. For example, after the status information in the molding period from the molding start time to the molding end time has been stored in the storage unit 24 in association with the operating period information, the display process proceeds to step S4.

At step S4, the display control unit 36 displays a display screen (see FIG. 3) showing the operation history of the injection molding machine 12, on the display unit 22, based on the stored pieces of information in the storage unit 24, i.e., the feature values and the cycle information stored in association with each other, the event information and the occurrence period information stored in association with each other, and the status information and the operating period information stored in association with each other.

More specifically, the display control unit 36 causes the display unit 22 to display the first graphs showing the temporal change of feature values and the second graphs showing the temporal change of events, with the time axes of the first graph and the second graph being defined in the same direction on the same scale. At this time, the display control unit 36 displays the first marks for the feature values on the first graphs and the second marks for the events on the second graphs, in a selectable manner (i.e., such that the marks can be selected). In addition, the display control unit 36 causes the display unit 22 to display an indicator showing the temporal transition of the operating state, by using the time axis defined in the same direction on the same scale as the first graphs and the second graphs. When the display screen (see FIG. 3) showing the operation history of the injection molding machine 12 is displayed on the display unit 22, the display process proceeds to step S5.

At step S5, the display control unit 36 determines whether a second mark displayed on the second graph has been selected. Here, when, for example, a second mark is clicked, the display control unit 36 determines that the second mark has been selected. In this case, the display process proceeds to Step S6. On the other hand, when, for example, no second mark is clicked, the display control unit 36 determines that no second mark has been selected. In this case, the display process proceeds to Step S7.

At step S6, the display control unit 36 changes the display mode according to the selected second mark. For example, when a second mark in the second graph showing the temporal change of alarming (alarm generation) in the injection molding machine 12 is selected, the display control unit 36 changes the current display mode into the display mode illustrated in FIG. 4. That is, the display control unit 36 highlights the time zone of the first graphs corresponding to the time region to which the selected second mark belongs, and also highlights the selected second mark and other second marks that indicate the events of the same content as the selected second mark.

Further, for example, when a second mark is selected from the second marks in the second graph showing the temporal change of operator's operation on the injection molding machine 12 (control on the molding machine), the display control unit 36 displays a detailed screen illustrated in FIG. 5. That is, the display control unit 36 causes the display unit 22 to display a detailed screen in which the details of events that have occurred within a predetermined period including the time corresponding to the selected second mark are listed in temporal order. When the change of the display mode according to the selected second mark is completed, the display process proceeds to step S7.

At step S7, the display control unit 36 determines whether a threshold TH has been set for a feature value. When no threshold TH is set through the input unit 20, the display control unit 36 determines that the threshold TH is not set for the feature value. In this case, the display process returns to step S5. On the other hand, when a threshold TH has been set through the input unit 20, the display control unit 36 determines that the threshold TH has been set for the feature value. In this case, the display process proceeds to Step S8.

At step S8, the display control unit 36 extracts data points at which the feature value is equal to or greater than the threshold TH set at step S7, and displays, in place of the first graph, the third graph showing the temporal change of the extracted feature value on the display unit 22, as results of appropriateness (good or bad) for the peak pressure. When the third graph is displayed on the display unit 22, the display process returns to Step S5.

### Modified Examples

The above embodiment may be modified as follows.

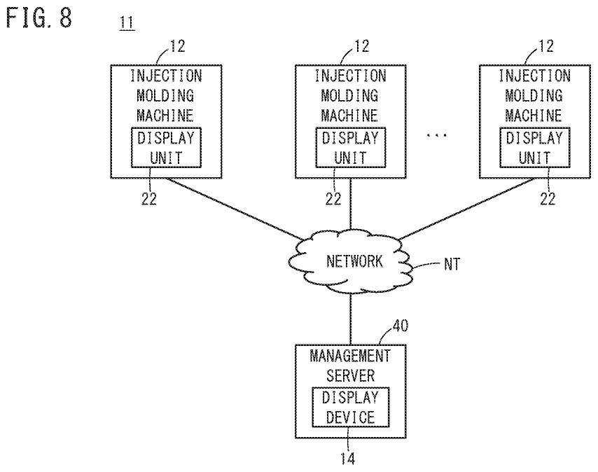

FIG. 8 is a block diagram showing a configuration of an injection molding system 11 in a modified example. In FIG. 8, the same reference numerals are allotted to the same components as those described in the above embodiment. In this modified example, description overlapping with the above embodiment is omitted.

The injection molding system 11 includes a plurality of injection molding machines 12 and a management server 40 that manages the multiple injection molding machines 12. Each of the multiple injection molding machines 12 and the management server 40 are connected via a network NT to exchange various kinds of information with each other.

Each of the multiple injection molding machines 12 has a display unit 22 for displaying information while the management server 40 has the display device 14 of the above embodiment.

The first storage control unit 30 of the display device 14 acquires feature values of physical quantities measured for each molding cycle of each of the injection molding machines 12, and stores the acquired feature values in the storage unit 24 in association with the cycle information.

The second storage control unit 32 of the display device 14 acquires event information indicating the details of events event that have occurred in each of the multiple injection molding machines 12, and stores the acquired event information in the storage unit 24 in association with the occurrence period information.

The third storage control unit 34 of the display device 14 acquires status information. indicating the operation status of each of the multiple injection molding machines 12, and stores the acquired status information in the storage medium of the storage unit 24 in association with the operating period information.

The display control unit 36 of the display device 14 displays a predetermined display screen, based on the stored pieces of information in the storage unit 24, i.e., the feature values stored in association with the cycle information, the event information stored in association with the occurrence period information, and the status information stored in association with the operating period information,.

That is, the display control unit 36 displays the display screen (see FIG. 3) showing at least one of the operation histories of the multiple injection molding machines 12, on at least one of the display unit 22 of the management server 40 (display device 14) and the display units 22 of the multiple injection molding machines 12.

With this configuration, an operator that is remote from a specific injection molding machine 12 can grasp the operation history of the injection molding machine 12. Further, the operation history of a certain injection molding machine 12 can be shared by multiple operators.

### Inventions Obtained from the Above

Inventions that can be grasped from the above-described embodiment and modified example will be described below.

### First Invention

The first aspect of the invention resides in the display device (14) for displaying the operation history of an injection molding machine (12), including:

a first storage control unit (30) configured to acquire a feature value of a physical quantity measured in each molding cycle of the injection molding machine (12) and store the acquired feature value in a storage unit (24) in association with cycle information indicating the molding cycle in which the feature value was measured;

a second storage control unit (32) configured to acquire event information indicating the content of each of events that have occurred in the injection molding machine (12), and store the acquired event information in the storage unit (24) in association with occurrence period information indicating an occurrence time period of each of the events; and

a display control unit (36) configured to, based on the cycle information and the occurrence period information, cause a display unit (22) to display a first graph showing the temporal change of the feature value and a second graph showing the temporal change of the events, with the time axes of the first graph and the second graph being defined in the same direction on the same scale. The display control unit (36) is configured to display marks respectively indicating the events, in the second graph in a manner that the marks are selectable.

With this configuration, a mark that indicates the event of interest can be selected, so that it is possible to reduce the risk of the operator losing track of the information to be focused on, without reducing the amount of information displayed on one screen. Thus, the operator can easily access the necessary information even if there is a large amount of information displayed.

The feature value may include at least one of the cycle time of the molding cycle, the injection time of the resin, the metering time for the resin, the peak injection pressure of resin injection, and the front end position at which the screw for resin injection has reached the forefront position. With this configuration, the operator can grasp the characteristic tendency of the injection molding machine (12).

The display control unit (36) may be configured to display the second graph for each of types of the events. With this configuration, the operator can grasp the detailed operation history of the injection molding machine (12).

The display control unit (36) may be configured to display the marks a manner that at least one of color, shape, and pattern of each of the marks differs according to types of the events. With this configuration, the tendency of each event type can be easily understood.

The event may include at least one of alarm generation from the injection molding machine (12), operator's operation on the injection molding machine (12), and change of molding conditions of the injection molding machine (12). With this configuration, the operator can grasp the tendency of the characteristic events in the injection molding machine (12).

The display control unit (36) may be configured to extract data points at which the feature value is equal to or greater than a threshold set for the feature value or extract data points at which the feature value is smaller than the threshold, and cause the display unit (22) to display a third graph showing the temporal change of the extracted data points of the feature value, with the time axis of the third graph being defined in the same direction on the same scale as the first graph. Thus, it is possible to clearly grasp at what time and how often the feature value becomes equal to or greater than the threshold, or becomes lower than the threshold. In addition, when extraction of the data points of the feature value that is equal to or greater than the threshold or that is smaller than the threshold is used to discriminating between non-defective molding products and defective molding products, the operator can use the third graph as an index of the presence or absence of defective molding products.

The display control unit (36) may be configured to extract data points at which the feature value is equal to or greater than a threshold set for the feature value or extract data points at which the feature value is smaller than the threshold, and highlight the extracted data points of the feature value on the first graph. Thus, it is possible for the operator to clearly grasp at what time and how often the feature value becomes equal to or greater than the threshold, or becomes lower than the threshold.

The display control unit (36) may be configured to, when a mark is selected from the marks displayed in the second graph, highlight the selected mark and another mark of the marks that indicates an event, among the events, that has the same content as that of the selected mark. As a result, it is possible for the operator to clearly grasp at what time and how often the event having the same content as the selected mark has occurred.

The display control unit (36) may be configured to, when a mark is selected from the marks displayed in the second graph, highlight the time zone corresponding to the time region to which the selected mark belongs, in the first graph. Thus, it is possible to clearly grasp the tendency of the feature value within, and before and after the time zone corresponding to the time region in which a specific event occurs.

The display control unit (36) may be configured to, when a mark is selected from the marks displayed in the second graph, cause the display unit. (22) to display a detailed screen in which the details of events, among the events, that have occurred within a predetermined period including the point of time corresponding to the selected mark are listed in temporal order. Thus, it is possible for the operator to grasp in detail the tendency around. the point of time when a specific event occurred.

The display control unit (36) may be configured to cause at least one of the display unit in a management server (40) that manages multiple injection molding machines (12) and the display units in the multiple injection molding machines (12) managed by the management server (40) to perform displaying. Thus, the operator that is remote from a specific injection molding machine (12) can grasp the operation history of the injection molding machine (12). Further, the operation history of a certain injection molding machine (12) can be shared by multiple operators.

### Second Invention

The second invention resides in a display method for displaying the operation history of an injection molding machine (12), including:

a first storing step (S1) of acquiring a feature value of a physical quantity measured in each molding cycle of the injection molding machine (12) and storing the acquired feature value in a storage unit (24) in association with cycle information indicating the molding cycle in which the feature value was measured;

a second storing step (S2) of acquiring event information indicating the content of each of events that have occurred in the injection molding machine (12) and storing the acquired event information in the storage unit (24) in association with occurrence period information indicating an occurrence time period of each of the events; and

a displaying step (S4) of, based on the cycle information and the occurrence period information, causing a display unit to display a first graph showing the temporal change of the feature value and a second graph showing the temporal change of the events, with the time axes of the first graph and the second graph being defined in the same direction on the same scale. In this method, the displaying step (S4) displays marks respectively indicating the events, in the second graph in a manner that the marks are selectable.

With this configuration, a mark that indicates the event of interest can be selected, so that it is possible to reduce the risk of the operator losing track of the information to be focused on, without reducing the amount of information displayed on one screen. Thus, the operator can easily access the necessary information even if there is a large amount of information displayed.

The above display method may further include an extracting and displaying step (S8) of extracting data points at which the feature value is equal to or greater than a threshold set for the feature value or extracting data points at which the feature value is smaller than the threshold, and causing the display unit (22) to display a third graph showing the temporal change of the extracted data points of the feature value, with a time axis of the third graph being defined in the same direction on the same scale as the first graph. Thus, it is possible for the operator to clearly grasp at what time and how often the feature value becomes equal to or greater than the threshold, or becomes lower than the threshold. In addition, when extraction of the data points of the feature value that is equal to or greater than the threshold or that is smaller than the threshold is used to discriminating between non-defective molding products and defective molding products, the operator can use the third graph as an index of the presence or absence of defective molding products.

The above display method may further include a display changing step (S6) of, when a mark is selected from the marks displayed in the second graph, highlighting the selected mark and another mark of the marks that indicates an event, among the events, that has the same content as that of the selected mark. As a result, it is possible for the operator to clearly grasp at what time and how often the event having the same content as the selected mark has occurred.

The above display method may further include a display changing step (S6) of, when a mark is selected from the marks displayed in the second graph, highlighting the time zone corresponding to the time region to which the selected mark belongs, in the first graph. Thus, it is possible for the operator to clearly grasp the tendency of the feature value within, and before and after the time zone corresponding to the time region in which a specific event occurs.

The above display method may further include a display changing step (S6) of, when a mark is selected from the marks displayed in the second graph, causing the display unit (22) to display a detailed screen in which the details of events, among the events, that have occurred within a predetermined period including a point of time corresponding to the selected mark are listed in temporal order. Thus, it is possible for the operator to grasp in detail the tendency around the point of time when a specific event occurred.

The present invention is not particularly limited to the embodiment described above, and various modifications are possible without departing from the essence and gist of the present invention.

What is claimed is:

1. A display device for displaying an operation history of an injection molding machine, comprising:
a first storage control unit configured to acquire a feature value of a physical quantity measured in each molding cycle of the injection molding machine, and store the acquired feature value in a storage unit in association with cycle information indicating the molding cycle in which the feature value was measured;
a second storage control unit configured to acquire event information indicating content of each of events that have occurred in the injection molding machine, and store the acquired event information in the storage unit in association with occurrence period information indicating an occurrence time period of each of the events; and
a display control unit configured to, based on the cycle information and the occurrence period information, cause a display unit to display a first graph showing temporal change of the feature value and a second graph showing temporal change of the events, with time axes of the first graph and the second graph being defined in a same direction on a same scale,
wherein the display control unit is configured to display marks respectively indicating the events, in the second graph in a manner that the marks are selectable.

2. The display device according to claim 1, wherein the feature value includes at least one of a cycle time of the molding cycle, an injection time of resin, a metering time for resin, a peak injection pressure of resin injection, and a front end position at which a screw for resin injection has reached a forefront position.

3. The display device according to claim 1, wherein the display control unit is configured to display the second graph for each of types of the events.

4. The display device according to claim 3, wherein the display control unit is configured to display the marks in a manner that at least one of color, shape, and pattern of the marks differs according to types of the events.

5. The display device according to claim 3, wherein the event includes at least one of alarm generation from the injection molding machine, operator's operation on the injection molding machine, and change of molding conditions of the injection molding machine.

6. The display device according to claim 1, wherein the display control unit is configured to extract data points at which the feature value is equal to or greater than a threshold set for the feature value or extract data points at which the feature value is smaller than the threshold, and cause the display unit to display a third graph showing temporal change of the extracted data points of the feature value, with a time axis of the third graph being defined in a same direction on a same scale as the first graph.

7. The display device according to claim 1, wherein the display control unit is configured to extract data points at which the feature value is equal to or greater than a threshold set for the feature value or extract data points at which the feature value is smaller than the threshold, and highlight the extracted data points of the feature value on the first graph.

8. The display device according to claim 1, wherein the display control unit is configured to, when a mark is selected from the marks displayed in the second graph, highlight the selected mark and another mark of the marks that indicates an event, among the events, that has a same content as that of the selected mark.

9. The display device according to claim 1, wherein the display control unit is configured to, when a mark is selected from the marks displayed in the second graph, highlight a time zone corresponding to a time region to which the selected mark belongs, in the first graph.

10. The display device according to claim 1, wherein the display control unit is configured to, when a mark is selected from the marks displayed in the second graph, cause the display unit to display a detailed screen in which details of events, among the events, that have occurred within a predetermined period including a point of time corresponding to the selected mark are listed in temporal order.

11. The display device according to claim 1, wherein the display control unit is configured to cause at least one of a display unit in a management server that manages multiple injection molding machines and the display units in the multiple injection molding machines managed by the management server to perform displaying.

12. A display method for displaying an operation history of an injection molding machine, comprising:
a first storing step of acquiring a feature value of a physical quantity measured in each molding cycle of the injection molding machine and storing the acquired feature value in a storage unit in association with cycle information indicating the molding cycle in which the feature value was measured;
a second storing step of acquiring event information indicating content of each of events that have occurred in the injection molding machine and storing the acquired event information in the storage unit in association with occurrence period information indicating an occurrence time period of each of the events; and
a displaying step of, based on the cycle information and the occurrence period information, causing a display unit to display a first graph showing temporal change of the feature value and a second graph showing temporal change of the events, with time axes of the first graph and the second graph being defined in a same direction on a same scale,
wherein the displaying step displays marks respectively indicating the events, in the second graph in a manner that the marks are selectable.

13. The display method according to claim 12, further comprising an extracting and displaying step of extracting data points at which the feature value is equal to or greater than a threshold set for the feature value or extracting data points at which the feature value is smaller than the threshold, and causing the display unit to display a third graph showing temporal change of the extracted data points of the feature value, with a time axis of the third graph being defined in a same direction on a same scale as the first graph.

14. The display method. according to claim 12, further comprising a display changing step of, when a mark is selected from the marks displayed in the second graph, highlighting the selected mark and another mark of the marks that indicates an event, among the events, that has a same content as that of the selected mark.

15. The display method according to claim 12, further comprising a display changing step of, when a mark is selected from the marks displayed in the second graph, highlighting a time zone corresponding to a time region to which the selected mark belongs, in the first graph.

16. The display method according to claim 12, further comprising a display changing step of, when a mark is selected from the marks displayed in the second graph, causing the display unit to display a detailed screen in which details of events, among the events, that have occurred within a predetermined period including a point of time corresponding to the selected mark are listed in temporal order.
